(19) United States
(12) Patent Application Publication
(10) Pub. No.: US 2017/0291524 A1
(43) Pub. Date: Oct. 12, 2017

(54) COMFORT SYSTEM FOR SEATING BACKS WITH REDUCTION IN PUR VOLUME AND ENVIRONMENTALLY FRIENDLY CONSTRUCTION

(71) Applicant: LEAR CORPORATION, Southfield, MI (US)

(72) Inventors: ASHFORD ALLEN GALBREATH, TROY, MI (US); ASAD S. ALI, TROY, MI (US); ASIF RASHIDI, TROY, MI (US); VINEETHA GHEEVARUGHESE, LAKE ORION, MI (US); MARIE-EVE COTE, ROYAL OAK, MI (US); MICHELLE ANNE PERENY, FARMINGTON HILLS, MI (US)

(21) Appl. No.: 15/357,276

(22) Filed: Nov. 21, 2016

Related U.S. Application Data
(60) Provisional application No. 62/321,175, filed on Apr. 11, 2016.

(51) Int. Cl. B60N 2/68; B60N 2/58; B60N 2/66

(52) U.S. Cl. CPC B60N 2/686; B60N 2/66; B60N 2/58

(57) ABSTRACT

A seatback support shell for a vehicle seat includes a shaped resinous sheet defining a top side, a bottom side, a first lateral side, and a second lateral side when the seatback support shell is positioned in a vehicle seat. The shaped resinous sheet has a convex section and a non-convex section with the convex section being positioned below the non-convex section when the seatback support shell is positioned in a vehicle seat.

### CROSS-REFERENCE TO RELATED APPLICATIONS

This application claims the benefit of U.S. provisional application Ser. No. 62/321,175 filed Apr. 11, 2016, the disclosure of which is hereby incorporated in its entirety by reference herein.

### BACKGROUND

Prior vehicle seat back designs are disclosed in U.S. Pat. Nos. 5,769,498; 6,283,552; and 6,802,563, for example.

### TECHNICAL FIELD

In at least one aspect, the present invention is related to vehicle seats having a rigid or semi-rigid back support shell positioned in a layered seat structure.

### SUMMARY

The present invention solves one or more problems of the prior art by providing in at least one embodiment a seatback support shell for a vehicle seat. The seatback support shell includes a shaped resinous sheet defining a top side, a bottom side, a first lateral side, and a second lateral side when the seatback support shell is positioned in a vehicle seat. The shaped resinous sheet has a convex section and a non-convex section with the convex section being positioned below the non-convex section when the seatback support shell is positioned in a vehicle seat. The shaped resinous sheet is formed from a thermoplastic polymer (e.g., expanded polypropylene, polyethylene terephthalate (PET). If expanded polypropylene (EPP), it may have a preferred density from 30 to 80 grams per liter. Advantageously, the present embodiment can reduce the amount or polyurethane foam (i.e., PUR volume) in a vehicle seat.

In another embodiment, a vehicle seat incorporating the seatback as set forth above is provided. The vehicle seat includes a seatback having a seatback frame, a seat bottom positioned below the seatback, and a seatback support shell attached to the seatback frame. The seatback support shell includes a shaped resinous sheet defining a top side, a bottom side, a first lateral side, and a second lateral side when the seatback support shell is position in a vehicle seat. The shaped resinous sheet has a convex section and a non-convex section with the convex section being positioned below the non-convex section when the seatback support shell is positioned in a vehicle seat. The shaped resinous sheet is formed from a thermoplastic polymer (e.g., expanded polypropylene, PET, etc.). If EPP, it may have a preferred density from 30 to 80 grams per liter.

### BRIEF DESCRIPTION OF THE DRAWINGS

FIG. 1 is a perspective view of a vehicle seat incorporating a seatback support shell made from a thermoplastic polymer;

FIG. 2 is a cross section of the vehicle seat of FIG. 1;

FIG. 3A provides a perspective view of a seatback support shell used in the vehicle seat of FIG. 1;

FIG. 3B provides a front view of a seatback support shell used in the vehicle seat of FIG. 1;

FIGS. 4A-C are horizontal cross-sections of the seatback support shell of FIGS. 3A and 3B;

FIG. 5 is a vertical cross-section of the seatback support shell of FIGS. 3A and 3B; and

FIG. 6 provides plots of load versus deflection for vehicle seats with seatback support shells made from various types of resinous sheets compared to a commercial product.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

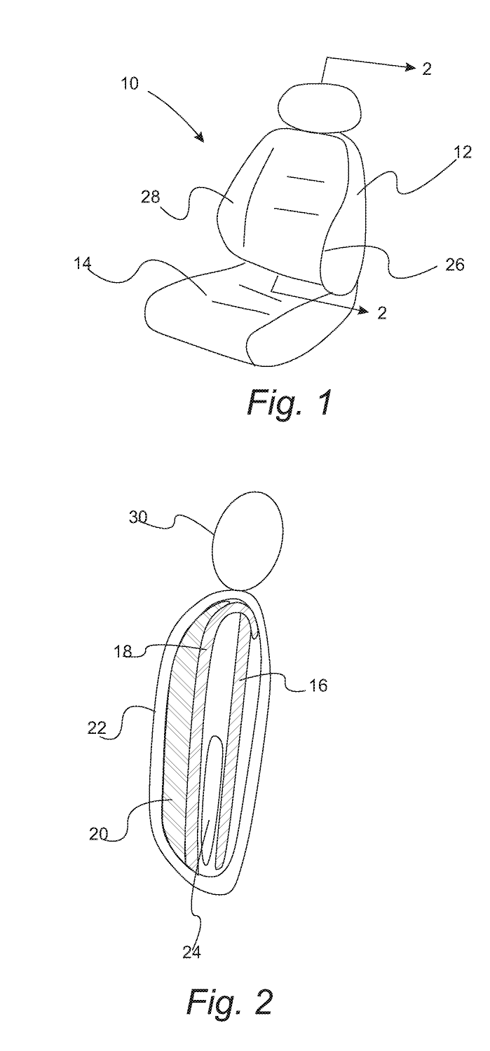

With reference to FIGS. 1 and 2, a layered vehicle seat is schematically illustrated. FIG. 1 is a perspective view of a vehicle seat while FIG. 2 is a cross section of the vehicle seatback. Vehicle seat 10 includes seatback 12 and seat bottom 14. Seat bottom 14 is positioned below seatback 12 to form vehicle seat 10. Seatback 12 includes seatback frame 16 which provides structural support. Seatback shell 18 is attached (e.g., slide over frame or snapped on to frame) to seatback frame 16. Pad 20, which may be typical comfort foam such as polyurethane foam, topper pad, spacer fabrics etc., is positioned between seatback support shell 18 and trim cover 22. A trim cover covers both seatback 12 and seat bottom 14. In a refinement, bladder 24 is positioned between trim cover 22 and seat seatback support shell 18, or between seatback support shell 18 and seatback frame 16. Bladder 24 may be selectively inflated for the purpose of promoting the seat occupant's comfort or appropriately positioning the occupant. Mechanical or other actuators may also replace bladder 24 for the same purpose. Vehicle seat 10 also includes seat bolsters 26, 28 which extend from the lateral sides of seatback 12 and head restraint 30 positioned at the top of seat bottom 12. In a refinement, shaped resinous sheet is not or only minimally deformable under pressure applied by an occupant sitting in a vehicle seat incorporating the seatback support shell. However, to provide comfortable support by the rigid or semi-rigid shell incorporated shapes are used to provide support to occupant's back. Also in a refinement, seat bottom 14 may be similarly formed as seatback 12, with a frame, a shell comprised of the materials and/or composites discussed below, a pad, and a trim cover.

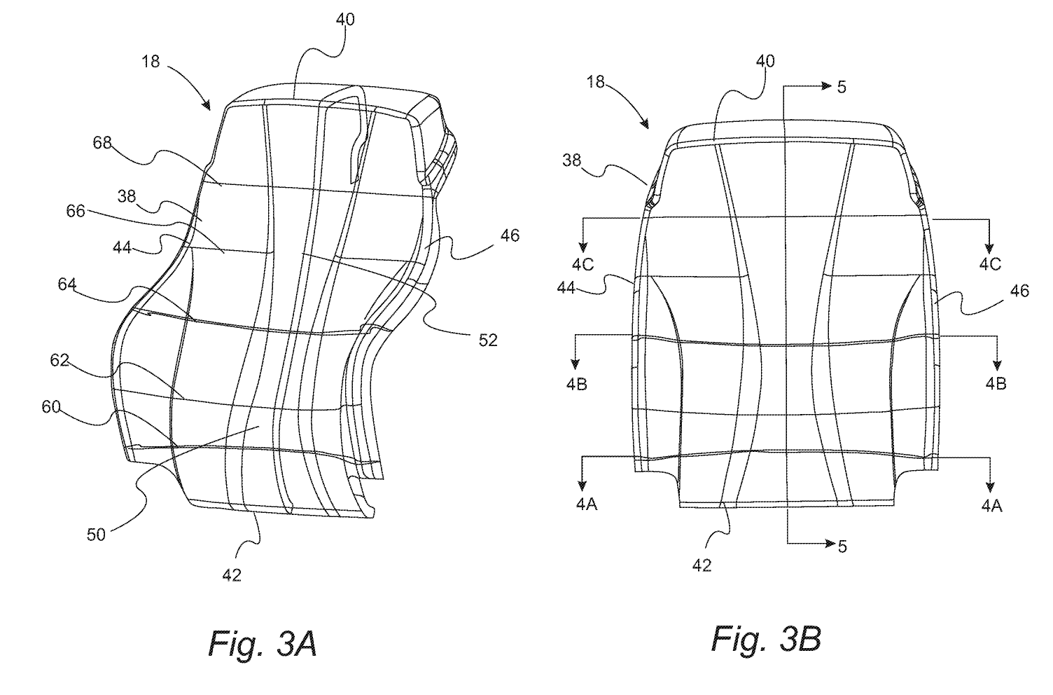

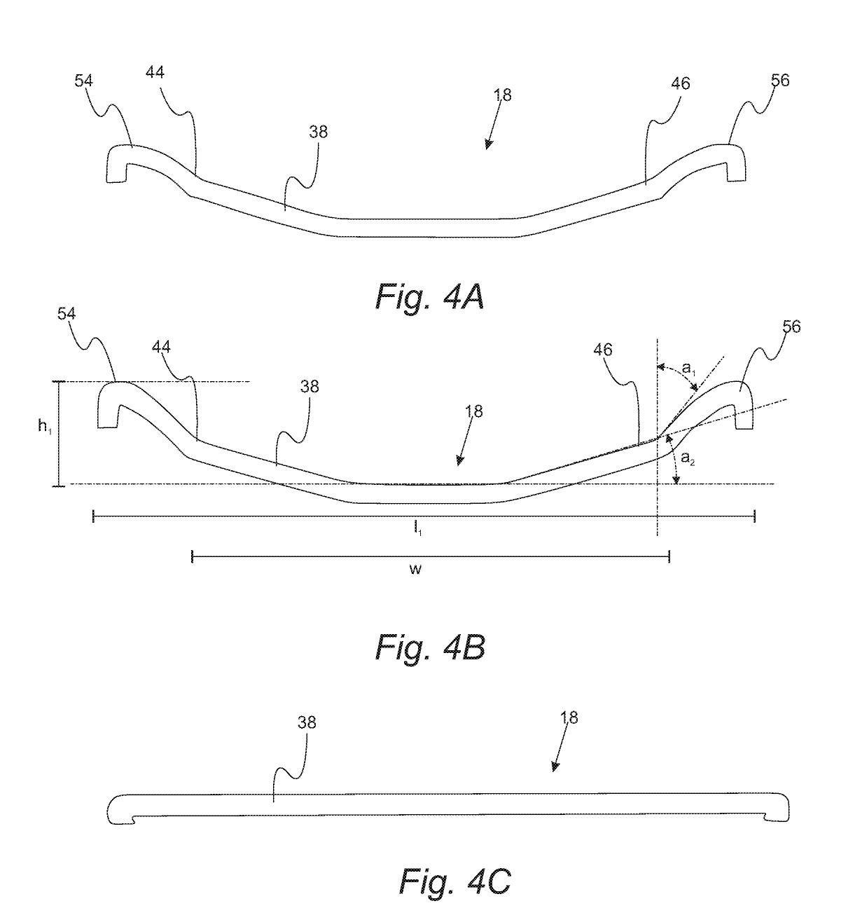

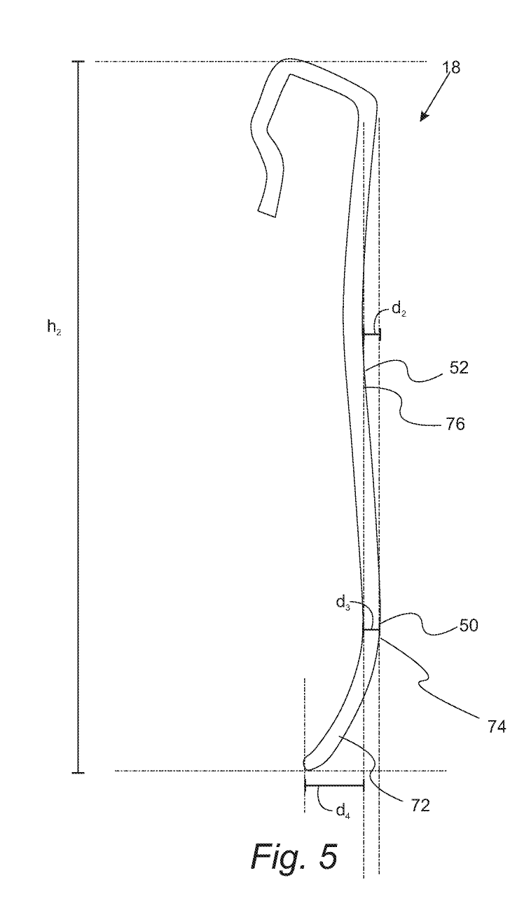

With reference to FIGS. 3A-B, 4A-C and 5, seatback support shell 18 is schematically illustrated. FIG. 3A provides a perspective view of the seatback support shell while FIG. 3B is a front view the seatback support shell. FIGS. 4A-C provide horizontal sections of the seatback support shell of FIGS. 3A and 3B while FIG. 5 provides a vertical section of the seatback support shell of FIGS. 3A and 3B. Seatback shell 18 includes a shaped resinous sheet 38 defining a top side 40, a bottom side 42, a first lateral side 44, and a second lateral side 46. Shaped resinous sheet can be formed from a single polymeric layer or from multiple polymeric layers. The position of these sides is defined with respect to when the seatback support shell is within a vehicle seat positioned with a vehicle. Shaped resinous sheet 38 has a convex section 50 and a non-convex section 52 with the convex section being positioned below the non-convex section when the seatback support shell is positioned in a vehicle seat. Shaped resinous sheet 38 is formed from a thermoplastic polymer. Examples of suitable thermoplastic polymers include, but are not limited to, expanded polypropylene (EPP), polyethylene terephthalate (PET), PET copolymers, and composites thereof, and combinations thereof. Composite layers include the thermoplastic polymer and filler or fibrous materials such as felt, Azdel, and shoddy. In a refinement, shaped resinous sheet 38 incudes a first thermoplastic layer and a second thermoplastic layer, each layer independently including a thermoplastic polymer. In some variations, shaped resinous sheet 38 includes PET fibers that may be held together with a binder. As such, the fibers may include bi-component fibers comprising PET. Resinous sheet 38 may be substantially entirely PET or may be formed of, for example, 50% to 60% PET and the remainder CoPET. In a refinement, shaped resinous sheet 38 has a thickness from about 5 to 50 mm. In another refinement, shaped resinous sheet 38 has a thickness from about 15 to 25 mm. Thickness and density can be changed to provide an appropriate level of rigidity. Shaped resinous sheet 38 can be molded from any number of processes such as compression molding, injection molding, and the like. Molding may be performed at temperatures from 300 to 450° C.

FIG. 4A is a horizontal cross section near the bottom of seatback support shell 18 near the design seating reference point (SgRP) and near the low back region of seated occupants. FIG. 4B is a horizontal cross section at the mid back low thoracic region of seated occupants. FIG. 4C is a horizontal cross section near the top of the seatback support shell 18 at or near upper back shoulder region of seated occupants. These figures show first bolster section 54 and second bolster section 56 extending from first lateral side 44 and second lateral side 46 of shaped resinous sheet 38, respectively. In a refinement, shaped resinous sheet defines plurality of imaginary transverse lines 60-68 that match the shape of an occupant back. In this context, matching the shape of an occupant's back means if the seatback support shell was brought sufficiently close to a vehicle occupant's back, the transverse lines would contact a vehicle occupant's back at a plurality of points along the length of the transverse lines. In a refinement, a first transverse line is positioned at or near the lumbar region of a vehicle occupant's spine and a second transverse line is positioned at or near the thoracic region of a vehicle occupant's spine, a third transverse line is positioned at or near a height of a vehicle occupant's hips and a fourth transverse line is positioned at or near a height of a vehicle occupant's shoulder.

The shape of the shell shown in FIGS. 4A-C can be described using 4 major dimensions: insert width, bolster angle, bolster height, and lateral shape. The insert width is typically the length l₁ of the shell excluding the bolster regions. In a refinement, l₁ is from 220 to 340 mm. The bolster angle a₁ is the angle by which the bolster region initially diverges from the insert region. Typically, the bolster angle is 20 to 90 degrees. The bolster height h₁ is the maximum distance of the top of the bolster to the lowest point on the insert region as measured on the same surface. In a refinement, the bolster height is from 75 to 150 mm. The lateral shape a₂ is the angle between the outer insert regions and a horizontal line passing through the flat section of the insert region. Typically, the lateral shape is 0 to 35 degrees.

FIG. 5 depicts a cross section at the centerline of seatback support shell 18. This figures show convex section 50 and a non-convex section 52 of shaped resinous sheet 38. In a variation, convex section 50 and non-convex section 52 have a longitudinal centerline that matches the shape of a vehicle occupant's spine from the lumbar region to the thoracic region. In this context, matching the shape of an occupant's spine means that if the seatback support shell was brought sufficiently close to a vehicle occupant's back, the longitudinal centerline would contact a vehicle occupant's back at a plurality of points along the length of the transverse lines. Typically, convex section 50 is positioned near or at the height of the lumbar region of a vehicle occupant, and non-convex section 52 is positioned near or at the height of the thoracic region of a vehicle occupant when the seatback support shell is positioned in a vehicle seat. The shape of the shell section shown in FIG. 5 can be described using 4 major dimensions: overall height, thoracic shape, lumbar support shape, and sacral relief shape. The overall height h₂ is typically from 400 to 750 mm. The thoracic shape d₂ is the maximum spatial extent of the concavity. Typically, d₂ is from 0 to 15 mm. The lumbar support shape is the distance of the convexity. Typically, d₃ is from 0 to 20 mm. The sacral relief d₄ is the distance of the concavity in the sacral region. Typically, d₄ is from 0 to 100 mm.

In a refinement, extremum 72 of the convex section 50 is positioned at a distance of 50 to 150 mm above the SgRP (seating reference point) 74. The SgRP is the height corresponding to a SAEJ826 manikin's H-point. In a refinement, non-convex section 52 is a concave section with respect to the side positioned away from the seatback frame. In a refinement, extremum 76 of the concave section 52 is positioned at a distance of 200-500 mm above the SgRP.

As set forth above, the seatback support shell of FIGS. 1-5 includes a shaped resinous sheet formed from a thermoplastic polymer. If the thermoplastic is EPP, it may have a density from 30 to 80 grams per liter. In a further refinement, the polymer has a density from 50 to 60 grams per liter. Table 1 provides preferred properties of the EPP sheet used in the seatback support shell set forth above. Of particular utility are the values corresponding to densities of 30 to 80 grams per liter. In a refinement, the thermoplastic polymer comprising the seatback support shell has tensile strength from 400 kPa to 1000 kPa and a tensile elongation from 15 to 20 percent. In another refinement, the thermoplastic polymer can also have a compress strength at 25% strain from 150 kPa to 500 kPa, at 50 percent strain from 200 kPa to 700 kPa, and at 75% strain from 460 kPa to 1600 kPa and a tensile elongation from 15 to 20 percent and/or a compression strength at 25% strain from 150 kPa to 500 kPa, at 50 percent strain from 200 kPa to 700 kPa, and at 75% from 460 kPa to 1000 kPa.

TABLE 1
Preferred EPP properties.

| Physical | Test | UNITS | Tested Densities | | | | | | |
|---|---|---|---|---|---|---|---|---|---|
| Properties | Method | g/l | 20 | 30 | 40 | 50 | 60 | 80 | 100 |
| Tensile Strength | ISO 1798 | kPa | 270 | 450 | 560 | 670 | 760 | 960 | 1150 |
| | DIN 53571 | | | | | | | | |
| Tensile Elongation | | % | 21 | 20 | 19 | 18 | 17 | 15 | 13 |
| Compressive Strength | ISO 844 | kPa | | | | | | | |
| 25% Strain | DIN 53421 | | 80 | 150 | 210 | 275 | 340 | 500 | 700 |
| 50% Strain | Test speed | | 150 | 200 | 300 | 370 | 475 | 700 | 960 |
| 75% Strain | 5 mm/min | | 350 | 460 | 600 | 800 | 1000 | 1600 | 2300 |
| Compressive Strength | ISO 1856 C | % | 13.5 | 12.5 | 12.0 | 12.0 | 11.5 | 11.5 | 11.5 |
| 25% Strain-22 h-23° C. | Stabilizing 24 H | | | | | | | | |
| Stauchharte | ISO 3386 | kPa | 80 | 105 | 125 | 140 | 150 | 170 | 185 |
| | 40% strain | | | | | | | | |
| Burning Rate | FMVSS 302 | mm/min | 100 | 80 | 60 | 50 | 40 | 30 | 25 |
| | ISO 3795 | | | | | | | | |
| | sample thickness | | | | | | | | |
| | 12.5 mm | | | | | | | | |

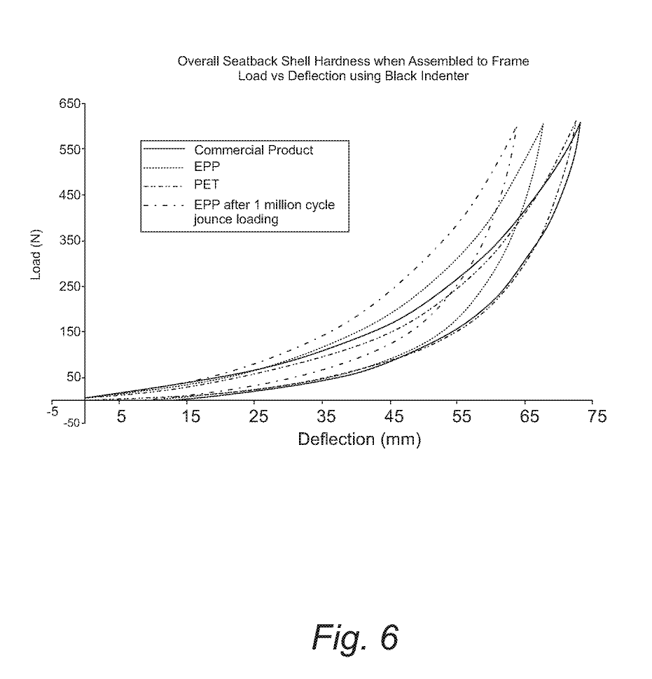

A useful feature of the seatback support shell is that this component provides structural strength, shape, support, and flexibility when a vehicle seat is occupied by a vehicle occupant. FIGS. 6 provides plots of load versus deflection for vehicle seats with seatback support shells made from various types of resinous sheets. These plots show that EPP and PET are firmer than a shell made from commercially available composites (the commercial product). FIG. 6A also shows that the EPP does not lose its structural strength even after 1 million jounce cycles but shows an increase in firmness as expected. For added flexibility for side bolster support, the shell can be designed with localized thin areas with semi-rigid material to allow flexibility. Finally, Table 2 demonstrates flexibility of the shell with bladder inflation for commercial shell versus the seatback support shells of the embodiments set forth above.

TABLE 2
Flexibility of the shell with bladders inflation when
bladders packaged behind shell

| | Inflated vs Deflated Bladders | | |
|---|---|---|---|
| | Right Bolster | Left Bolster | Back lumbar area |
| Commercial Product | 17.1 mm | 23.63 mm | 48.75 mm |
| PET | 16.53 mm | 16.87 mm | 25.5 mm |
| EPP | 21.29 mm | 28.6 mm | 33 mm |

The preferred embodiments of the present invention provide a rigid or semi-rigid shell used as the basis for a layered seating application. The shell provides both occupant comfort and support and has a shape to support the occupant both longitudinally and laterally. The layered seat configuration is lightweight and substantially recyclable.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seatback support shell comprising:
a shaped resinous sheet defining a top side, a bottom side, a first lateral side, and a second lateral side when the seatback support shell is positioned in a vehicle seat, the shaped resinous sheet having a convex section and a non-convex section, the convex section being positioned below the non-convex section when the seatback support shell is positioned in a vehicle seat, the shaped resinous sheet comprising a thermoplastic polymer, the thermoplastic polymer being selected from the group consisting of expanded polypropylene (EPP), PET, PET copolymers, composites thereof, and combinations thereof.

2. The seatback support shell of claim 1 wherein the convex section is positioned at a height of a lumbar region of a vehicle occupant and the non-convex section is positioned at a height of a thoracic region of a vehicle occupant when the seatback support shell is positioned in a vehicle seat.

3. The seatback support shell of claim 1 wherein an extremum of the convex section is positioned at a distance of 50 to 150 mm above the SgRP.

4. The seatback support shell of claim 1 wherein the non-convex section is a concave section positioned at a distance of 200 to 500 mm above the SgRP.

5. The seatback support shell of claim 1 wherein the shaped resinous sheet has a thickness from about 5 to 50 mm.

6. The seatback support shell of claim 1 wherein the thermoplastic polymer has compression strength at 25% strain from 150 kPa to 500 kPa, at 50 percent strain from 200 kPa to 700 kPa, and at 75% strength from 460 kPa to 1000 kPa.

7. The seatback support shell of claim 1 wherein the convex section and non-convex section have a longitudinal center line that matches the shape of a vehicle occupant's spine from a lumbar region to a thoracic region.

8. The seatback support shell of claim 1 wherein the shaped resinous sheet has a plurality of transverse lines that matches the shape of an occupant's back, the transverse lines being configured to contact a vehicle occupant's back at a plurality of points along a length of the transverse lines when the seatback support shell is positioned against the vehicle occupant's back.

9. The seatback support shell of claim 8 wherein a first transverse line is positioned at the lumbar region of a vehicle occupant's spine and a second transverse line is positioned at the thoracic region of a vehicle occupant's spine, a third transverse line is positioned at a height of a vehicle occupant's hip and a fourth transverse line is positioned at a height of a vehicle occupant's shoulder.

10. The seatback support shell of claim 1 wherein the shaped resinous sheet is rigid where shape does not change when occupants sits in a seat incorporating seatback support shell.

11. A vehicle seat comprising:
a seatback having a seatback frame;
a seat bottom below the seatback; and
a seatback support shell attached to the seatback frame, the seatback support shell comprising a shaped resinous sheet defining a top side, a bottom side, a first lateral side, and a second lateral side when the seatback support shell is positioned in a vehicle seat, the shaped resinous sheet having a convex section and a non-convex section, the convex section being positioned below the non-convex section when the seatback support shell is positioned in a vehicle seat, the shaped resinous sheet comprising thermoplastic polymer, the thermoplastic polymer being selected from the group consisting of expanded polypropylene (EPP), PET, PET, and copolymer composites thereof, and combinations thereof.

12. The vehicle seat of claim 11 further comprising a trim cover disposed over the seatback frame and the seat bottom.

13. The vehicle seat of claim 12 further comprising a cushioning layer comprising of foam, spacer materials, bladders positioned between the seatback frame and the trim cover.

14. The vehicle seat of claim 11 wherein the convex section is positioned at the height of the lumbar region of a vehicle occupant and the non-convex section is positioned at the height of the thoracic region of a vehicle occupant when the seatback support shell is positioned in a vehicle seat.

15. The vehicle seat of claim 11 wherein an extremum of the convex section is positioned at a distance of 50 to 150 mm above the H-point.

16. The vehicle seat of claim 11 wherein the non-convex section is a concave section.

17. The vehicle seat of claim 16 wherein an extremum of the concave section is positioned at a distance of 200 to 500 mm above the H-point.

18. The vehicle seat of claim 11 wherein a first bolster section extends from the first lateral side and a second bolster section extends from the second lateral side, the first bolster section and the second bolster section defining a first seat bolster and a second seat bolster in the vehicle seat.

19. The vehicle seat of claim 11 wherein the convex section and non-convex section have a longitudinal center line that matches the shape of a vehicle occupant's spine from the lumbar region to the thoracic region.
